(19) United States
(12) Patent Application Publication
(10) Pub. No.: US 2012/0097759 A1
(43) Pub. Date: Apr. 26, 2012

(54) MISTING HUMIDIFYING AND EVAPORATIVE COOLING SIMULATED FLORA

(76) Inventor: Charles Vigne, Fort Meyers, FL (US)

(21) Appl. No.: 12/912,626

(22) Filed: Oct. 26, 2010

(51) Int. Cl. B05B 1/00

(52) U.S. Cl. 239/211

(57) ABSTRACT

A plurality of artificial tree or plant trunks each have vertically spaced directional multiple misting nozzles at various desired heights on pipes camouflaged as bamboo poles or thick stems or trunks of other plants. The simulated trunks and simulated shoots of the same species are anchored in a firm water sealed mulch in a pot with artificial leaves and thin stems attached to the simulated trunks for a complete simulated potted tree or plant. The series of vertically spaced and variously angled misting heads produce mist at various desired heights aimed in various desired directions for a variety of functions. Liquid mist or a humidifier mist may be sprayed with a humidifier or fog machine or high pressure compressor attached.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to artificial or simulative flora and particularly to a simulated plant or tree for misting or humidifying or providing evaporative cooling for an area comprising simulated tree or plant trunks made from PVC pipe, misting tips screwed into the simulated trunks at various desired heights and angles, a pot for holding the plant and a water hose connection near the bottom of the exterior of the pot which delivers fluid to the simulated trunk, and artificial or real branches and leaves inserted in the pot and/or attached to the simulated trunks for a complete simulated potted tree or plant providing a series of vertically spaced misting heads in vertical pipes producing mist at various desired heights aimed in various desired directions for a variety of functions.

2. Description of Related Art Including Information Disclosed Under 37 CFR 1.97 and 1.98

It is often desirable to cool a person or persons in a hot environment, particularly while sunbathing, and also to cool or humidify an area or room. Various machines or pipe systems have been used in the past for such purposes. Often they are unattractive and do not enhance an area in which they are located. While some attempts at using simulated plants have been made, they typically provide sprays from simulated flowers aimed upwardly. The prior art lacks the capability of provides a number of misting spouts positioned and directed as desired to adequately provide multiple mist sprays in multiple selected directions for cooling a number of people and cooling and humidifying a relatively large area in a device which fits attractively into the environment.

U.S. Pat. No. 6,592,053, issued Jul. 15, 2003 to Ericksen et al, provides an evaporative cooling unit that sprays a water mist into the air to cool the air by evaporation of the water mist is disguised as to its function and purpose by including the misting nozzles and water supply conduits in a decorative structure, such as an artificial flower arrangement or plant. The misting unit of the invention includes a base and a decorative structure extending from the base. A water conduit extends through the base from a base end with a fitting for attachment to a source of pressurized water such as a garden hose, into the decorative structure where it ends in at least one decorative structure end with a misting nozzle thereon. The base may take the form of a flower pot with the decorative structure taking the form of flowers or a plant extending from the flower pot.

U.S. Pat. No. 5,121,882, issued Jun. 16, 1992 to Skidmore, is for an apparatus for delivering a water mist to sunbathers comprising: a pair of pipe sections having perforations along the lengths thereof for mounting mist producing nozzles, a flexible hose connecting the pipes one to the other, and a valve at an inlet to the pipe assembly for controlling the flow of water through the pipes. A cap at one end of the apparatus seals the pipe assembly and causes water flowing into the pipes to be forced through the nozzles, thereby producing a fine mist. The flexible hose not only permits adjustment of the distance between the pipes to facilitate use by a number of sunbathers, but also enables the apparatus to be folded for transportation or storage. U.S. Pat. No. 6,592,049, issued Jul. 15, 2003 to Wolput, shows a water misting device having a hook and loop fastener connected to a nozzle mounting assembly. The nozzle mounting assembly has an inlet tube bore and a connected nozzle bore. A misting nozzle is attached to the nozzle mounting assembly. A water inlet tube is connected to the nozzle mounting assembly. An electrically driven water pump is connected to the water inlet tube. A timer is electrically connected to the water pump for selectively powering the water pump to intermittently force the flow of water through the water pump. A power supply connection is electrically connected to the timer.

U.S. Pat. No. 1,989,525, issued Jan. 29, 1935 to Moore, describes a simulative lawn sprinkler which has a plurality of bendable tubes that are led from a single hose coupling. Each bendable tube is designed to be a flower stem and allows water to reach its flower head which is provided with a sprinkler device.

U.S. Pat. #D95,443, issued Apr. 30, 1935 to McCormick, discloses the ornamental design for a combined lawn sprinkler and bird bath.

U.S. Pat. #D153,334, issued Apr. 12, 1949 to Beaver, indicates the ornamental design for a lawn sprinkler.

U.S. Pat. #D100,087, issued Jun. 23, 1936 to Butt, puts forth the ornamental design for a lawn sprinkler.

U.S. Pat. No. 6,443,849, issued Sep. 3, 2002 to Byrd, concerns a recreation system resembling a jungle scene which is provided with platform elements surrounded by and elevated by support members disguised to look like bamboo rods and tree branches with leaves. The support elements are generally made of pipe materials covered with foam and plastic cable ties so as to resemble bamboo. The tree branch elements are interlocking members designed to appear as tree branches and are changeable to allow for different configurations of tree elements by pulling the elements apart and then pushing them together in other configurations. The recreation system includes jungle and bird noises and simulated lightning and thunder which are activated during play on the recreation system. The recreation system allows the user to pretend to be in a jungle setting during play.

U.S. Patent Application #20020150699, published Oct. 17, 2002 by Box, is for a method of manufacturing artificial foliage utilizes a plastic pipe framework. The pipes are secured together to form a spine with a number of lateral members extending from it. The framework is wrapped with a layer of permeable fiberglass tape. A resin layer is coated on the fiberglass tape. The resin layer has a color and texture to simulate bark. Some of the resin permeates the fiberglass tape and contacts the pipes. Some of the pipes on the lateral members have upturned ends. Artificial leaves are attached to the resin layer on the lateral members.

U.S. Pat. No. 6,117,503, issued Sep. 12, 2000 to Lee et al, claims a method of making an artificial tree comprising a process of simulating rough bark on an artificial tree using the steps of coating the artificial tree surface with a thin layer of plastic foam and exposing the foam to a blast of concentrated heat sufficient to collapse part of the foam structure. A length of rigid PVC pipe is used for the trunk and holes are drilled into the pipe for branch placement.

U.S. Pat. No. 5,550,720, issued Aug. 27, 1996 to Carroll, shows an artificial Christmas tree with electric separable segments which is made from PVC pipe.

U.S. Pat. No. 7,306,167, issued Dec. 11, 2007 to Colarusso et al., claims an automatic mist-sprayer system comprising a control unit having electronic circuitry adapted to activate the sprayer for a predetermined interval in response to a sensed ambient light condition of desired intensity and duration. The system desirably further includes an electrical power supply and a plurality of spaced-apart sprayer heads. A preferred utility for the system of the invention is spraying dilute solutions of insecticide or insect repellent during the periods of significant insect activity that typically occur around dusk and dawn. Manual overrides and a remote receiving unit are also disclosed for use of the system at times other than dusk and dawn.

U.S. Pat. No. 5,487,502, issued Jan. 30, 1996 to Liao, provides a decorative device includes a main body for holding a decorative article in the main body, a container for filling a compressed fluid for producing odors or fragrance in the container, a driving device for opening and closing a releasing valve of the container as controlled by a control device, a discharge pipe connected to the container, a plurality of nozzles divergently branched from the discharge pipe and widely distributed in the decorative article, and a sound generating device electrically connected to the control device and mounted in the main body, whereby upon actuation of the control device, the releasing valve of the container will be opened by the driving device to spray vapor or gas of the fluid through the nozzles distributed in the decorative article for providing a smell (preferably a fragrant smell) from the decorative article and also for producing sound from the sound generating device for enhancing a decorative effect.

What is needed is an artificial tree or plant with vertically spaced directional multiple misting nozzles at various desired heights on pipes camouflaged as bamboo poles or thick stems or trunks of other plants anchored in a firm water sealed mulch in a pot with artificial leaves and thin stems for a complete simulated potted tree or plant providing a series of vertically spaced misting heads in vertical pipes producing mist at various desired heights aimed in various desired directions for a variety of functions.

### BRIEF SUMMARY OF THE INVENTION

An object of the present invention is to provide an artificial tree or plant with vertically spaced directional multiple misting nozzles at various desired heights on pipes camouflaged as bamboo poles or thick stems or trunks of other plants anchored in a firm water sealed mulch or simulated potting soil in a pot with artificial leaves and thin stems for a complete simulated potted tree or plant providing a series of vertically spaced misting heads in vertical pipes producing mist at various desired heights aimed in various desired directions for a variety of functions.

A further object of the present invention is to provide an optional humidifier by replacing the pot with a humidifying pot having a built-in humudifier.

In brief, a simulated plant or tree for misting or humidifying or providing evaporative cooling for an area and/or people in the area comprising vertical simulated trunks made from PVC pipe, misting tips screwed into the simulated trunks at various desired heights along the height of the simulated trunks and at a variety of selected positions around each simulated trunk, a pot for holding the simulated tree or plant having angled water transmittal connections at the bottom of the simulated trunks communicating with a water hook-up connection near the bottom of the exterior of the pot which delivers fluid to the simulated trunk from a water source, which may be a water hose connection. The simulated trunks and bottom water transmittal connections are anchored in a firm water sealed mulch or simulated potting soil in the pot with artificial or real leaves and thin stems attached to each simulated trunk and/or inserted in the pot for a complete simulated potted tree or plant providing a series of vertically spaced misting heads in vertical pipes producing mist at various desired heights aimed in various desired directions for a variety of functions.

A humidifier or a fog machine may also be used with the invention for humidifying or creating a fog through the simulated trunks.

A compressor may be used to create a high pressure system providing more air for greater evaporation.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the simulated plant for misting and humidifying of the present invention showing the simulated bamboo trunks with misting tips and simulated attached branches and a simulated plant shoot to be inserted in the pot with the simulated bamboo trunks and showing the pot with only dashed lines to reveal the PVC piping connections to the simulated bamboo trunks;

FIG. 1A is a partial perspective view of the simulated plant for misting and humidifying of FIG. 1 utilizing two simulated misting trunks attached by a T-connector to the source of fluid;

FIG. 1B is a partial perspective view of the simulated plant for misting and humidifying of FIG. 1 utilizing one simulated misting trunk attached by a straight connector to the source of water:

FIG. 2 is a cross-sectional view through the pot adjacent to and parallel to one arm of the PVC cross, showing the PVC pipe connections and the preferred fills used in the pot:

FIG. 3 is a cross-sectional view through the pot adjacent to and parallel to one arm of the PVC cross, showing the PVC pipe connections and a simulated mulch covering over the top of the pot and further showing a humidifier inside the pot having a humidifier output connected to the simulated trunks by a switching valve shared with the fluid input;

FIG. 4 is a partial perspective view of one of the simulated trunks of the simulated plant for misting and humidifying of FIG. 1 showing a front view of a flat face ground into a side of the simulated trunk to receive a misting head threaded into a threaded hole in the flat face with a rubber grommet sealing the connection;

FIG. 5 is a partial perspective view of one of the simulated trunks of the simulated plant for misting and humidifying of FIG. 1 showing a side view of a flat face ground into a side of the simulated trunk to receive a misting head threaded into a threaded hole in the flat face;

FIG. 6 is a cross-sectional view through the pot of the simulated plant for misting and humidifying of FIG. 1 taken adjacent to and parallel to one arm of the PVC cross, showing the PVC pipe connections and a simulated mulch covering over the top of the pot and showing a humidifier inside the pot having a humidifier output connected to the simulated trunks by an elbow and having a fluid intake through a top cap having a matching simulated mulch top surface connected to the humidifier water tank, and further showing an electric cord for the humidifier extending out a side of the pot adjacent to the bottom of the pot, and further showing a humidifier control opening in the simulated mulch top having a hinged door with a simulated mulch outer surface to access the humidifier controls on the top of the humidifier;

FIG. 7 is a cross-sectional view through the pot of the simulated plant for misting and humidifying of FIG. 1 taken adjacent to and parallel to one arm of the PVC cross, showing the PVC pipe connections and a simulated mulch covering over the top of the pot and showing a separate water tank for ballast inside the pot, the tank having a fluid intake through a top cap having a matching simulated mulch top surface connected to the tank;

FIG. 8 is a perspective view of the simulated plant for misting and humidifying of the present invention showing the simulated bamboo trunks with enlarged misting tips and simulated attached branches and a simulated or real plant shoot to be inserted in the pot with the simulated bamboo trunks and showing the pot with only dashed lines to reveal the PVC piping connections to the simulated bamboo trunks and a compressor for a high pressure misting system;

FIG. 9 is a perspective view of the simulated plant for misting and humidifying of the present invention showing the simulated bamboo trunks with misting tips and simulated attached branches and a simulated or real plant shoot to be inserted in the pot with the simulated bamboo trunks and showing the pot with only dashed lines to reveal the PVC piping connections to be simulated bamboo trunks and a fog machine for creating a fog in the air surrounding the simulated plant through the simulated trunks and through the pot;

FIG. 10 is a partial perspective view of a section of PVC pipe used to form a simulated bamboo pole trunk is painted with an almond or fossil plastic spray paint to simulate the basic color of the bamboo pole and kneaded 2-part epoxy putty is applied in shaped epoxy putty bands around the PVC pipe at regular spaced intervals along the height of the PVC pipe;

FIG. 11 is a partial perspective view of the section of PVC pipe used to form a simulated bamboo pole trunk of FIG. 10 showing the epoxy putty band scraped around the perimeter to form an annular notch in the epoxy putty band to replicate an internode between each of the jointed segments, called nodes, along the length of the simulated bamboo pole, and further showing the jointed segments between the nodes wiped with paint on a rag to provide a light strand look along the entire PVC pipe;

FIG. 12 is a perspective view of the simulated plant for misting and humidifying of the present invention showing the simulated bamboo trunks with misting tips and simulated attached branches and showing the pot with only dashed lines to reveal the PVC piping connections to be simulated bamboo trunks and an external fog machine piped into the pot for creating a fog in the air surrounding the simulated plant through the pot;

FIG. 13 is a perspective view of three of the simulated plants for misting and humidifying of the present invention showing the simulated bamboo trunks with misting tips and simulated attached branches and showing the pot with only dashed lines to reveal the PVC piping connections to the simulated bamboo trunks and further showing how a single fluid source attaches to a plurality of misting plants using a series of Y shaped hose connectors.

### DETAILED DESCRIPTION OF THE INVENTION

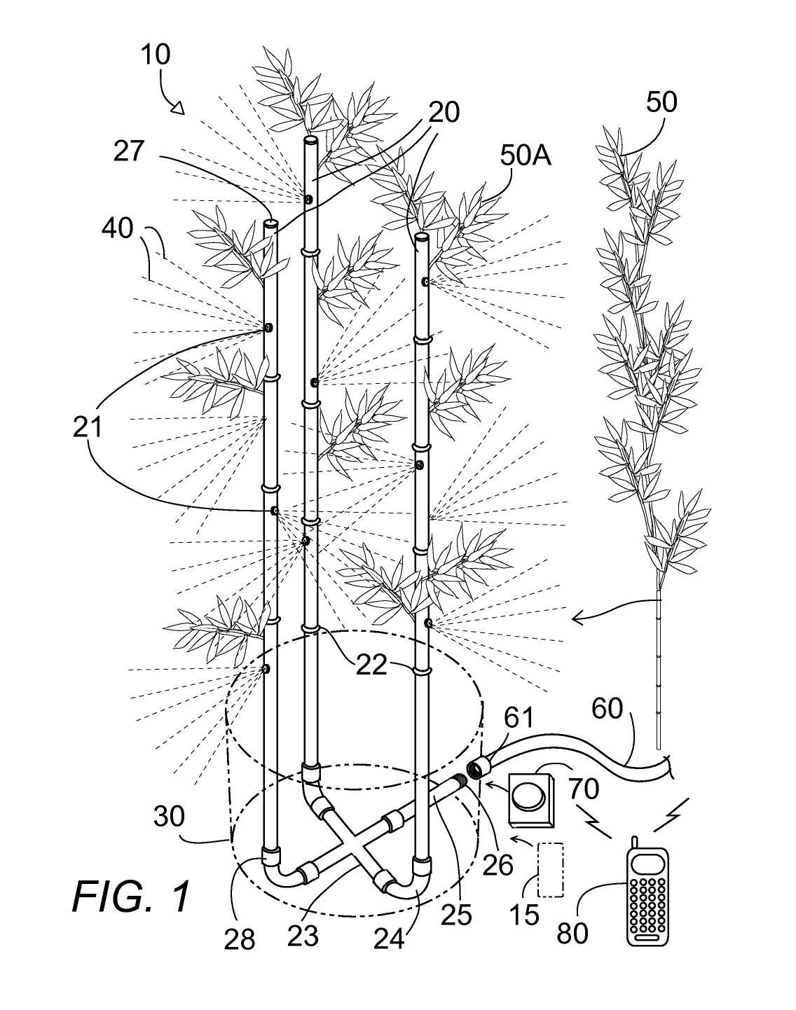

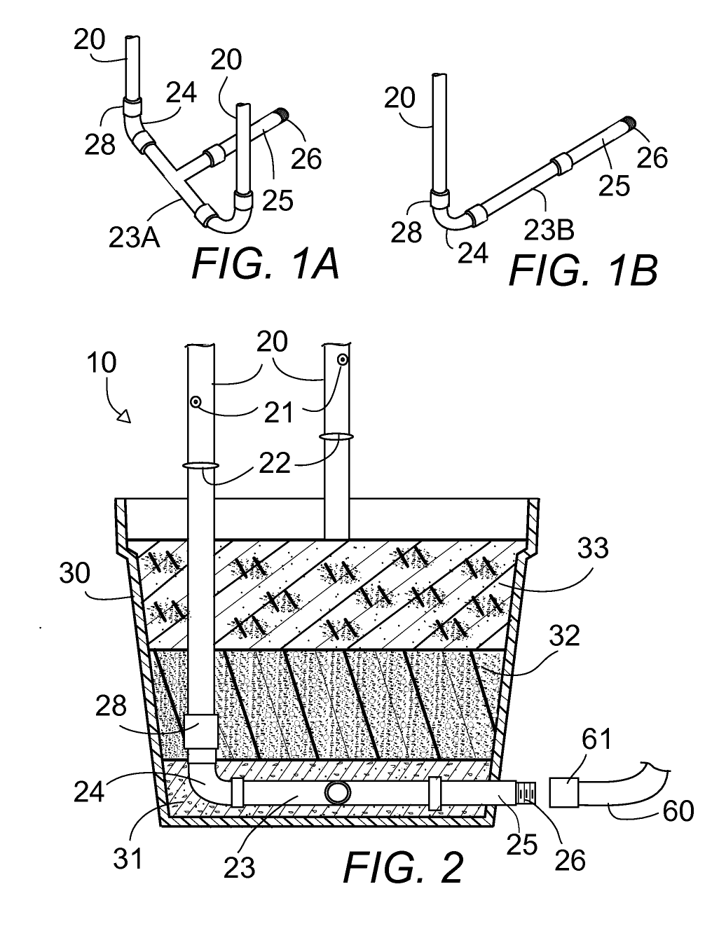

In FIGS. 1-13, a mist spraying simulated plant device 10 comprises at least one simulated misting trunk 20 with a plurality of misting fixtures 21 and simulated plant branches with leaves 50A and simulated or real plant shoots 50 in a planting pot.

The at least one simulated trunk 20 of a plant comprises at least one vertical liquid conduit having at least one interior liquid passageway along the length of the conduit and having exterior visual elements 22 applied thereto along an outside surface along the length of the conduit to form a simulated plant trunk for conducting liquid vertically.

The plurality of misting fixtures 21 are affixed to each simulated trunk 20, each having at least one opening therethrough to admit a mist spray 40 of liquid therethrough. Each of the plurality of misting fixtures 21 communicates with a liquid inside the at least one interior liquid passageway of a simulated trunk 20 to admit the mist spray 40 of the liquid under pressure outwardly through each of the plurality of misting fixtures 21. The plurality of misting fixtures are attached at desired heights and at desired angles and at desired positions around the at least one simulated trunk 20 to produce outwardly directed misting sprays 40 at desired heights and at desired angles around each of the simulated trunks for misting and humidifying a surrounding area, surrounding objects, and surrounding people around the at least one simulated trunk. An additional injector 15 may add aromatic and health providing substances to the liquid in the system for scented and healthy sprays.

The plurality of simulated branches 50A and leaves of the same species as the at least one simulated trunk 20 attached thereto and simulated or real shoots 50 of the same species are positioned adjacent thereto to form a mist spraying simulated plant.

The pot 30 holds the mist spraying simulated plant, and means for attaching a liquid conducting conduit to the at least one simulated trunk to apply liquid under pressure to the at least one simulated trunk.

The plurality of misting fixtures 21 preferably comprise a plurality of misting tips each screwed into any of a variety of threaded openings at a variety of desired locations in one of the simulated trunks 20 to produce a plurality of mists 40 at desired heights and in desired directions.

The at least one simulated trunk 20 preferably comprises a plurality of simulated bamboo poles trunks 20 and the simulated shoots 50, leaves 50A, and branches comprise simulated bamboo shoots, leaves, and branches, although other plants or miniature trees could be used.

The means for attaching a liquid conducting conduit to the simulated trunks 20 comprises a multi-branched liquid conduit 23 in the pot 30 attached by an elbow 24 to each of the at least one simulated trunks 20 wherein one of the liquid conduit branches 25 extends out of the pot and has a fixture 26, which may be a threaded end to connect to a water hose, at an outer end to connect with an external fluid conduit 60, which may be a water hose.

The at least one simulated trunk 20 preferably comprises three simulated bamboo trunks 20 formed from three vertical PVC pipes each connected by a threaded connector 27 to a bottom PVC elbow 24 to one outer end of a horizontal PVC cross 23 in the pot 30, wherein a fourth outer end of the PVC cross is attached to a PVC pipe 25 section which extends out of the pot 30, the PVC pipe connection having a fluid conduit connector 26 at an outer end outside of the pot 30 to connect with an external fluid conduit connector 61, which may be a threaded receiving connector on a water hose.

An optional programmable valve 70 is preferably attached to the PVC pipe 25 and the external fluid conduit 60 for controlling at least the timing of a flow of fluid from the external fluid conduit 60 into the at least one simulated trunk 20. A remote control 80 may be used for controlling the programmable valve 70. Another alternative is to provide a control valve for controlling the flow of the fluid in an external fluid conduit and use the remote control 80 for controlling the external control valve.

In FIG. 1A two simulated misting trunks 20 are attached by a T-connector 23A to the source of water 60 and in FIG. 1B one simulated misting trunk is attached by a straight connector 23B to the source of water 60.

In FIG. 2, the pot 30 preferably has a cement fill 31 at the bottom covering the PVC cross 23 but not the threaded connectors 27 for the simulated trunks 20 to be removably attached to the PVC cross. The cement fill 31 secures the PVC cross to support the simulated trunks 20 and provides a weight at the bottom of the pot to prevent it from tipping over. The cement 31 at the bottom is preferably covered with a spray foam layer 32 and topped with a rubber mulch mixed with urethane layer 33 to be waterproof and remain firm to help secure the simulated trunks 20 and simulated shoots 50 in place in the pot 30. It is understood that other fills may be used in the pot including natural soil or sand.

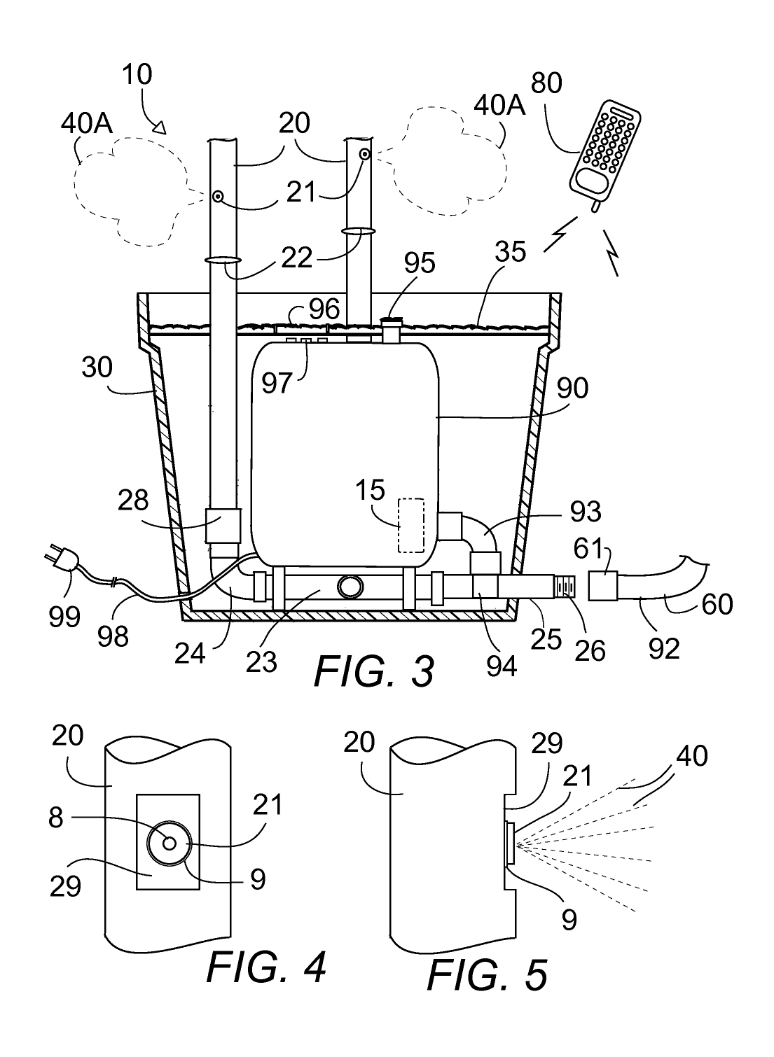

In FIG. 3, an optional humidifier 90 communicates with the at least one simulated trunk 20. The humidifier 90 has a humidifying outlet 93 and a switching valve 94 means for connecting the humidifying outlet 93 to the at least one simulated trunk liquid conduit branch 25 to apply a humidifying spray under pressure to the at least one simulated trunk 20 for the at least one simulated trunk to provide a humidifying spray 40A into a surrounding area. The switching valve 94 connects between a simulated trunk fluid liquid conduit branch 25 and the liquid conducting conduit 60 to switch back and forth between a connection to the humidifying outlet 93 for producing a humidifying spray 40A from the at least one simulated trunk 20. A simulated mulch covering 35, which may be molded plastic, is secured over the top of the pot with a fluid intake for the humidifier through a top cap 95, having a matching simulated mulch top surface, connected to the humidifier water tank.

In FIGS. 4 and 5, a flat face 29 is ground into a side of the simulated trunk 20 to receive a misting head 21 with a center misting opening 9 threaded into a threaded hole in the flat face 29 with a rubberized grommet 9 tightened flat against the flat face 29 for a more secure fit of the misting head with no leaking and for establishing the direction of the mist or humidifying cloud.

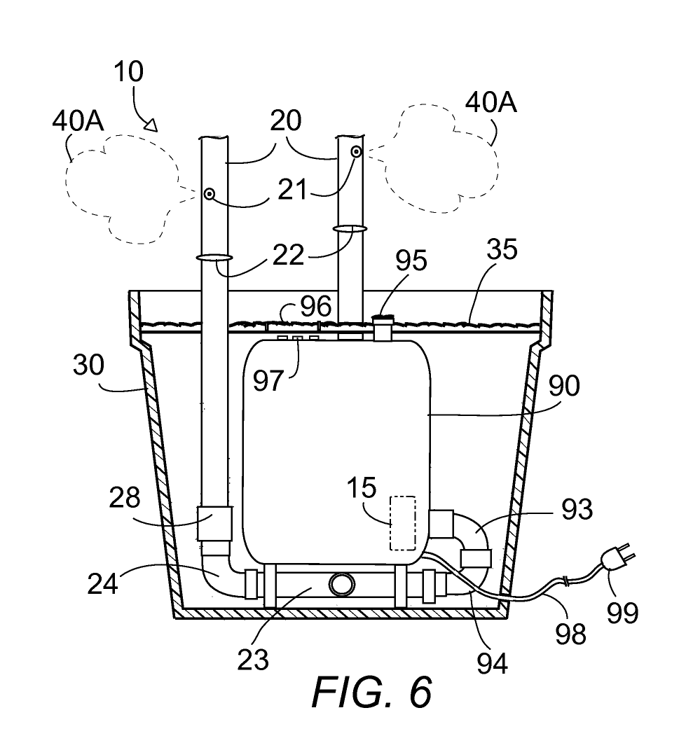

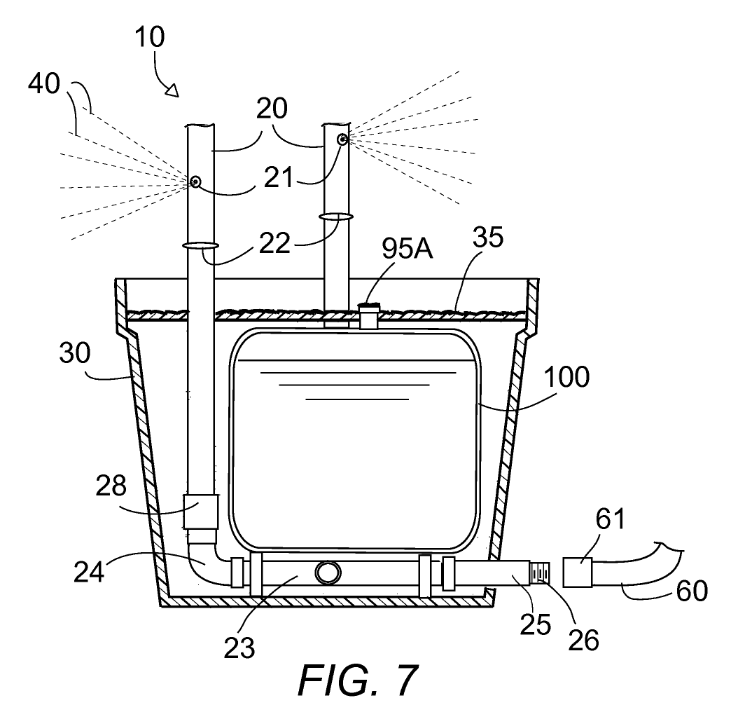

In FIG. 6, a humidifier 90 rests on legs on the bottom of the pot 30 over the PVC pipe connections 23 and a simulated mulch covering 35, which may be molded plastic, over the top of the pot with a fluid intake through a top cap 95 having a matching simulated mulch top surface connected to the humidifier water tank. A humidifier output 93 connects to the simulated trunks 20 by an elbow to the PVC pipes 23. An electric cord 98 with an end plug 99 extends from the humidifier 90 out a side of the pot adjacent to the bottom of the pot. A humidifier control opening in the simulated mulch top 35 has a hinged door 96 with a simulated mulch outer surface to access the humidifier controls 97 on the top of the humidifier. An additional injector 15 may add aromatic and health providing substances to the liquid in the humidifier for scented and healthy sprays.

In FIG. 7, a separate water tank 100 for ballast instead of the cement is inside the pot covered by a simulated mulch covering 35 over the top of the tank having a fluid intake to fill the tank through a top cap 95A having a matching simulated mulch top surface. This makes the pot light for transporting and moving around and then easily filled with water to weight it down at the final destination.

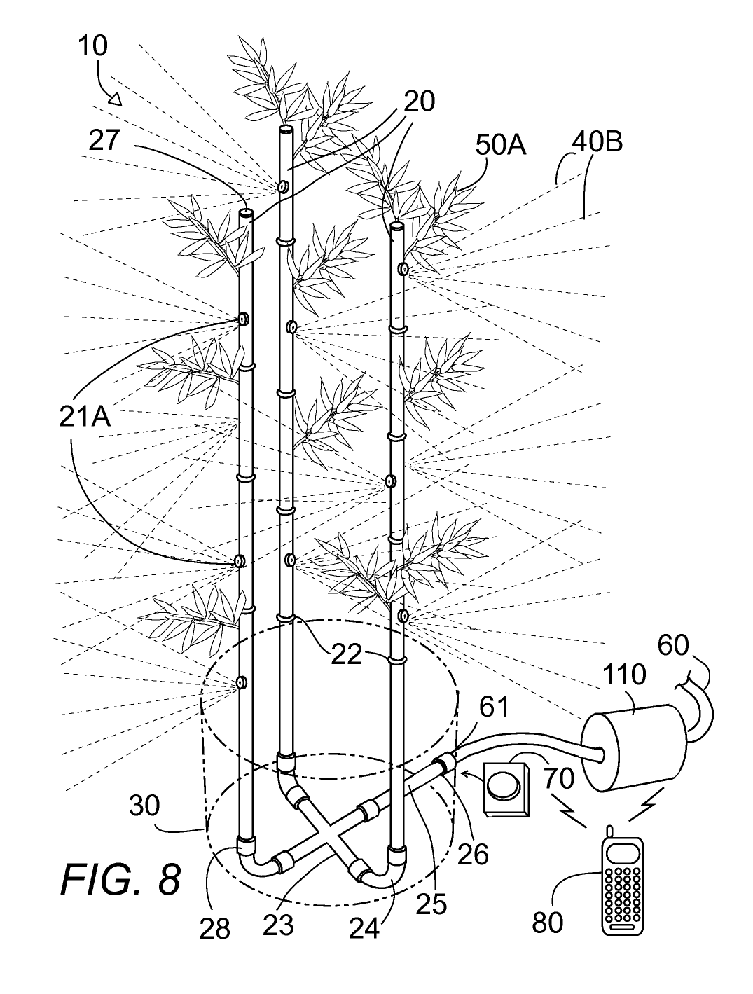

In FIG. 8, a compressor 110 communicates with the hose 60 and extended PVC pipe 25 means for supplying liquid to the simulated trunk to provide greater pressure to the liquid in the system for a high pressure misting system which provides a misting spray 40B with more air and greater evaporation than conventional low pressure systems using water tap pressure.

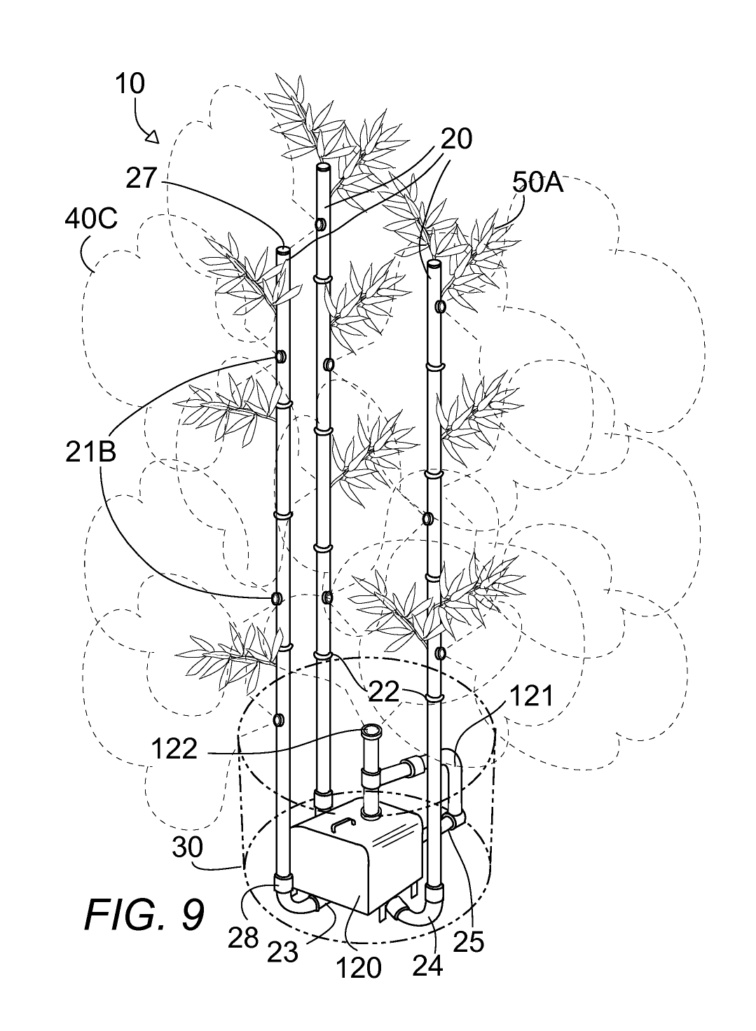

In FIG. 9, a fog machine 120 inside the pot 30, which may be covered by a simulated mulch is in FIG. 8, communicates with the simulated trunks 20 through a PVC connection 121 and the pot 30 through a top spout 122 from the fog machine for creating a fog 40D in the air surrounding the simulated plant through the simulated trunks and through the pot.

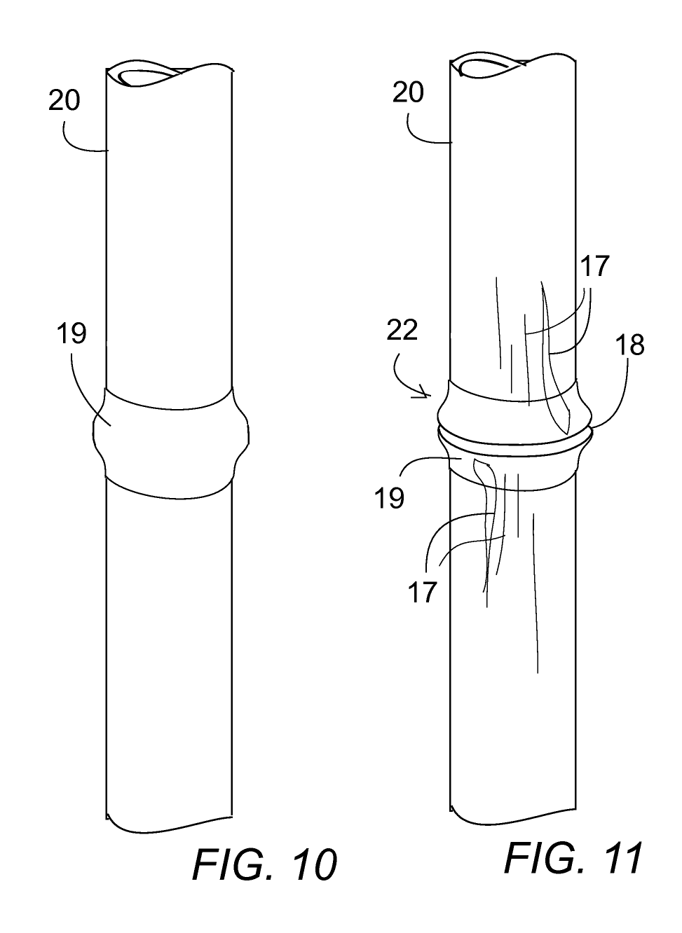

In FIGS. 10 and 11, a simulated bamboo pole trunk (in nature called a culm) starts with a PVC pipe 20 which is cleaned with acid tone and the flat surfaces 9 for the mist heads 21 grinded at a plurality of desired spaced locations along each of the PVC pipes. The PVC is painted with an almond or fossil plastic spray paint to simulate the basic color of the bamboo pole. Kneaded 2-part epoxy putty is applied in shaped epoxy putty bands 19 around the PVC pipe at regular spaced intervals along the height of the PVC pipe, as shown in FIG. 10. Each epoxy putty band 19 is scraped around the perimeter to form an annular notch 18 in the epoxy putty band 19, as shown in FIG. 11, to replicate a node 22 between each of the jointed segments, called internodes, along the length of the simulated bamboo pole. The nodes 22 and the jointed segments between the internodes are wiped with paint on a rag to provide a light strand look 17 along the entire PVC pipe and then covered with an exterior UV protected urethane to maintain the color simulating the bamboo pole.

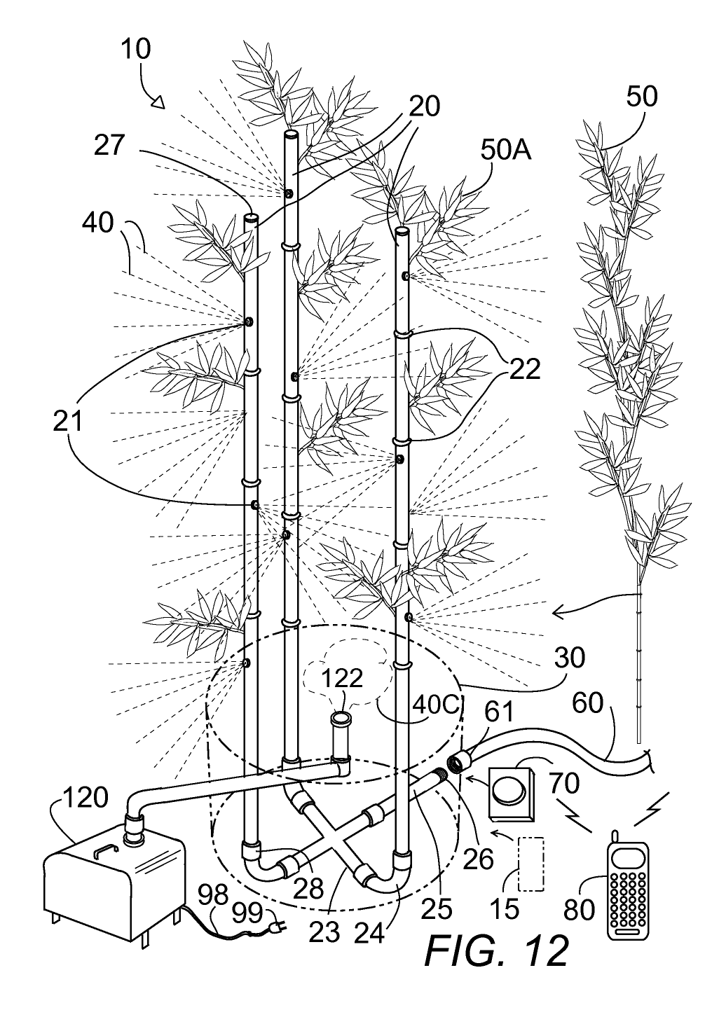

In FIG. 12, an external fog machine 120 piped into a fog output spout 122 in the pot 30 for creating a fog 40C in the air surrounding the simulated plant through the pot 30.

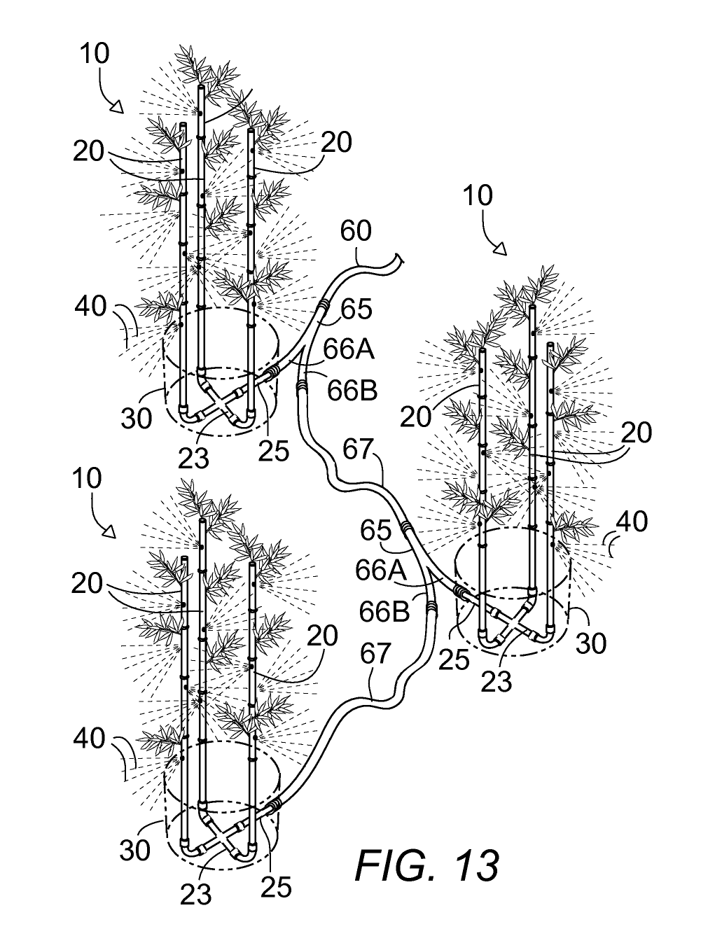

In FIG. 13 three of the simulated plants 10 in three pots 30 for misting and humidifying of the present invention showing the simulated bamboo trunks 20 with misting tips and simulated attached branches and showing the pots 30 with only dashed lines to reveal the PVC piping connections 23 to the simulated bamboo trunks 20 and further showing how a single fluid source 60, such as a garden hose, attaches to a plurality of misting plants using a series of Y shaped hose connectors 65 each having two arms 66A and 66B so that a first arm 66A branches off from the single fluid source hose 60 into the pipe extension 25 to supply the simulated trunks 20 with fluid and the second arm 66B connects to another section of hose 67 to connect with another Y shaped hose connector 65 with a first arm 66A connecting to another misting plant 10 and a second arm 66B connecting to another section of hose 67 and continuing in the same pattern to supply as many misting plants as desired from the single fluid source 60. The two arms 66A and 66B of the Y shaped hose connector 65 may each have a shutoff valve so that the mist spraying simulated plants 10 may be controlled individually.

The fluid conduits and simulated trunks for spraying are preferably PVC pipe of any desired diameter, but may be any other type of fluid conduit which can be camouflaged to look like a plant trunk. The pot may be wooden or preferably simulated wood made of a lighter material for easy transport and moving.

It is understood that the preceding description is given merely by way of illustration and not in limitation of the invention and that various modifications may be made thereto without departing from the spirit of the invention as claimed.

What is claimed is:

1. A mist spraying simulated plant device comprising:
at least one simulated trunk of a plant comprising at least one vertical liquid conduit having at least one interior liquid passageway along the length of the conduit and having exterior visual elements applied thereto along an outside surface along the length of the conduit to form a simulated plant trunk for conducting liquid vertically;
a plurality of misting fixtures affixed to each simulated trunk, each having at least one opening therethrough to admit a mist spray therethrough, each of the plurality of misting fixtures communicating with a liquid inside the at least one interior liquid passageway to admit a mist spray of the liquid under pressure outwardly through each of the plurality of misting fixtures, the plurality of misting fixtures attached at desired heights and at desired angles and at desired positions around the at least one simulated trunk to produce outwardly directed misting sprays at desired heights and at desired angles around each of the simulated trunks for misting and humidifying a surrounding area, surrounding objects, and surrounding people around the at least one simulated trunk;
a plurality of simulated branches and leaves of the same species as the at least one simulated trunk attached thereto and simulated or real shoots of the same species positioned adjacent thereto to form a mist spraying simulated plant;
a pot for holding the mist spraying simulated plant, and means for attaching a liquid conducting conduit to the at least one simulated trunk to apply liquid under pressure to the at least one simulated trunk.

2. The device of claim 1 wherein the plurality of misting fixtures comprise a plurality of misting tips each screwed into any of a variety of threaded openings at a variety of desired locations in one of the simulated trunks to produce a plurality of mists at desired heights and in desired directions.

3. The device of claim 2 wherein the simulated trunk is provided with a plurality of flat surfaces formed in the simulated trunk with a threaded opening in the center of each of the flat surfaces to receive a misting tip threaded therein, the misting tip further comprising a rubberized grommet resting flat against the flat surface to make a watertight seal.

4. The device of claim 1 wherein the means for attaching a liquid conducting conduit to the at least one simulated trunk comprises a multi-branched liquid conduit in the pot attached by an elbow and a top threaded connector to each of the at least one simulated trunks wherein one of the liquid conduit branches extends out of the pot and has a fixture at an outer end to connect with an external fluid conduit.

5. The device of claim 3 wherein the at least one simulated trunk comprises three simulated bamboo trunks formed from three vertical PVC pipes each connected by a bottom PVC elbow to one outer end of a horizontal PVC cross in the pot, wherein a fourth outer end of the PVC cross is attached to a PVC pipe section which extends out of the pot, the PVC pipe connection having a fluid conduit connector at an outer end outside of the pot to connect with an external fluid conduit.

6. The device of claim 3 wherein the at least one simulated trunk comprises two simulated bamboo trunks formed from two vertical PVC pipes each connected by a threaded connector and a bottom PVC elbow to one outer end of a horizontal PVC T-connector pipe in the pot, wherein a third outer end of the PVC T-connector pipe is attached to a PVC pipe section which extends out of the pot, the PVC pipe connection having a fluid conduit connector at an outer end outside of the pot to connect with an external fluid conduit.

7. The device of claim 3 wherein the at least one simulated trunk comprises one simulated bamboo trunk formed from a vertical PVC pipe connected by a threaded connector and a bottom PVC elbow to an end of a horizontal straight PVC pipe in the pot, wherein the outer end of the straight PVC pipe is attached to a PVC pipe section which extends out of the pot, the PVC pipe connection having a fluid conduit connector at an outer end outside of the pot to connect with an external fluid conduit.

8. The device of claim 1 further comprising a programmable valve between the at least one simulated trunk and an external fluid conduit for controlling at least the timing of a flow of fluid from the external fluid conduit into the at least one simulated trunk and a remote control for controlling the programmable valve.

9. The device of claim 1 wherein the pot is filled with a rubber mulch mixed with urethane to be waterproof and remain firm to secure the simulated trunks and simulated shoots in place in the pot.

10. The device of claim 1 further comprising a cement layer at a bottom of the pot for securing the means for attaching a liquid conducting conduit to the at least one simulated trunk to support the at least one simulated trunk and to provide a weight at the bottom of the pot to prevent it from tipping over, and a spray foam layer covering the cement layer and a rubber mulch mixed with urethane layer covering the rubber mulch mixed with urethane layer to provide waterproofing and to help secure the simulated trunks in place in the pot.

11. The device of claim 1 wherein the at least one simulated trunk comprises a plurality of simulated bamboo pole trunks and the simulated or real shoots, leaves, and branches comprise simulated or real bamboo shoots, leaves, and branches.

12. The device of claim 11 wherein each of the simulated bamboo pole trunks comprises a vertical PVC pipe and a plurality of simulated bamboo pole nodes formed by epoxy putty encircling the PVC pipe and shaped and scraped with an annular recess into each of the nodes and paint wiped onto the PVC pipe and the epoxy putty to simulate the surface of the simulated bamboo pole.

13. The device of claim 1 further comprising a humidifier communicating with the at least one simulated trunk, the humidifier having a humidifying outlet and means for connecting the humidifying outlet to the at least one simulated trunk to apply a humidifying spray under pressure to the at least one simulated trunk for the at least one simulated trunk to provide a humidifying spray into a surrounding area and means for supplying water to the humidifier.

14. The device of claim 13 wherein the humidifier rests on legs on the bottom of the pot over the PVC pipe connections and a simulated mulch covering covers the circumference of the pot over the top of the humidifier, the simulated mulch covering having a fluid intake opening to fill a humidifier reservoir and a top cap over the opening having a matching simulated mulch top surface, a humidifier output connects to the simulated trunks by a humidifier spray conduit to a simulated trunk fluid receiving conduit, an electric cord with an end plug extending from the humidifier out a side of the pot adjacent to the bottom of the pot.

15. The device of claim 14 wherein the simulated mulch covering has a humidifier control opening in the simulated mulch top having a hinged door with a simulated mulch outer surface to access humidifier controls on a top of the humidifier.

16. The device of claim 1 further comprising a separate water tank installed inside the pot for a fillable ballast, a simulated mulch covering attached to the pot over the top of the water tank, the simulated mulch covering having a fluid intake opening to fill the water tank and a top cap over the fluid intake opening, the top cap having a matching simulated mulch top surface.

17. The device of claim 1 further comprising a compressor communicating with the means for supplying liquid to the simulated trunk to provide greater pressure to the liquid in the system for a high pressure misting system.

18. The device of claim 1 further comprising a fog machine communicating with the simulated trunk and the pot for creating a fog in the air surrounding the simulated plant through the simulated trunks and through the pot.

19. The device of claim 1 further comprising means for adding aromatic and health providing substances to the liquid for scented and healthy mist sprays.

20. The device of claim 1 further comprising a plurality of Y shaped hose connector and a series of single hose sections attached between one arm of each of the plurality of Y shaped hose connectors and the single base hose of the next Y shaped hose connector while each of the other arms connect to one of the simulated plant misting device.
